(19) United States
(12) Patent Application Publication
(10) Pub. No.: US 2019/0234283 A1
(43) Pub. Date: Aug. 1, 2019

(54) ENGINE OUT NOx REDUCTION USING ENHANCED DEF

(71) Applicant: International Engine Intellectual Property Company, LLC, Lisle, IL (US)

(72) Inventors: Bradley Jay Adelman, Chicago, IL (US); Darren Gosbee, Maple Park, IL (US); Navte Singh, Arlington Heights, IL (US)

(21) Appl. No.: 15/884,816

(22) Filed: Jan. 31, 2018

(51) Int. Cl. F01N 13/00; F01N 3/20; F01N 3/035; B01D 53/94

(52) U.S. Cl. CPC F01N 13/009; F01N 3/2066; F01N 3/206; F01N 3/035; F01N 3/2006; B01D 53/9431; F01N 2610/1433; B01D 53/9477; F01N 2250/02; F01N 2370/02; F01N 2570/14; F01N 2610/02; F01N 2610/12; B01D 53/944

(57) ABSTRACT

Unenhanced DEF and anhydrous solid reductant capable of forming ammonia are mixed to create enhanced DEF which is injected into an engine exhaust aftertreatment system which performs selective catalytic reduction (SCR) of engine-out exhaust.

### TECHNICAL FIELD

This disclosure relates generally to selective catalytic reduction (SCR) of oxides of nitrogen (NOx) in “engine out” exhaust by injecting diesel exhaust fluid (DEF) which is stored in a DEF storage tank on-board a vehicle into an engine exhaust aftertreatment system.

### BACKGROUND

One technology for aftertreatment of diesel engine exhaust utilizes SCR to enable known chemical reactions which convert NOx into nitrogen (N₂) and water (H₂O), two constituents found in abundance in earth's atmosphere. A reaction may occur between only two reactants: 1) ammonia (NH₃) stored on surface sites of an SCR catalyst and NOx in the exhaust; or 2) those two reactants and an additional reactant, oxygen (O₂), if the latter is also present in the exhaust. Ammonia molecules reduce NOx by the following known chemical reactions:

4 NO+4NH₃+O₂→4N₂+6H₂O

NO+NO₂+2NH₃→2N₂+3H₂O

6NO₂+8NH₃→7N₂+12H₂O

For attaining compliance with applicable tailpipe emission standards, today's vehicles which are propelled by diesel engines commonly use DEF (known by other names such as AdBlue and AUS325 in certain geographic regions), a liquid solution 32.5 wt % urea dissolved in 67.5 wt % de-ionized water.

DEF is stored in a DEF storage tank on board a vehicle. The DEF storage tank is typically exposed to weather, and DEF in the tank will freeze when outside temperature falls below the DEF freezing point and the engine does not operate for an extended length of time. The specific 32.5%/67.5% DEF formulation provides DEF with a eutectic concentration where urea and water freeze/thaw at the same temperature, namely −12° C. (10° F.). In mixtures having urea concentrations greater than 32.5%, urea, but not water, freezes at temperatures different from the temperature at which the 32.5%/67.5% concentration freezes, and in mixtures having urea concentrations less than 32.5%, water, but not urea, freezes at temperatures different from the temperature at which the 32.5%/67.5% freezes.

Urea concentrations greater than 32.5% wt. would provide the possibility of more ammonia for NOx reduction per unit volume of DEF, but the 32.5%/67.5% standard solution is used to avoid the creation of either ice crystals or urea crystals in liquid DEF, conditions which could have an adverse effect on the ability of a DEF injection system to inject DEF in proper fluid quantity and/or at the 32.5% urea concentration.

While the water constituent of DEF provides a liquid medium in which urea will readily dissolve, the water needs to be evaporated by engine exhaust heat in order to release urea and the urea needs engine exhaust heat to decompose into ammonia so that ammonia molecules can attach to catalytic sites on washcoat surfaces of an SCR catalyst in the aftertreatment system and become available to reduce NOx in exhaust passing across those surfaces by catalytic conversion to N₂ and H₂O.

Quantities of DEF injected into the aftertreatment system are controlled in relation to engine operation and engine exhaust temperature in order to mitigate both ammonia slip and the formation of deposits on surfaces of the exhaust system. Flowing injected DEF and engine exhaust through a mixer may mitigate formation of deposits to some extent by improving the conversion of DEF to the desired reductant, ammonia, but adequate path length for flow through a mixer may be constrained by available packaging space for the aftertreatment system in a particular vehicle, or a mixer may have an undesired restrictive effect on exhaust flow. While aftertreatment regeneration events will decompose or react away deposits, more frequent use of such events to mitigate deposit formation can reduce fuel efficiency and exhaust system life. If ammonia slip cannot be limited to less than a specified tailpipe out quantity of ammonia, an ammonia slip catalyst downstream of an SCR catalyst may be needed at additional cost to an aftertreatment system.

### SUMMARY OF THE DISCLOSURE

This disclosure introduces apparatus and methods for creating “enhanced” DEF on-board an engine-powered vehicle by mixing an anhydrous ammonia-forming, water-miscible solid reductant (urea for example) with standard DEF having a 32.5% urea concentration to create a solution of greater reductant concentration which is then injected into an engine exhaust aftertreatment system where oxides of nitrogen (NOx) in the exhaust are converted into nitrogen (N₂) and water (H₂O) by catalytic reaction with ammonia (NH₃) which is released from the solution by exhaust heat. Standard DEF and “unenhanced DEF” will be used interchangeably here to mean DEF which has 32.5%/67.5% urea/water while “enhanced DEF” means a solution which has greater than 32.5% urea.

Enhanced DEF has a smaller percentage water component per unit volume of solution than standard DEF, and therefore requires a smaller quantity of engine exhaust heat per unit volume of enhanced DEF solution to evaporate the water component. That heat difference can be used to convert some of the increased urea component into ammonia with the remainder of the urea component being converted by additional engine exhaust heat.

Because enhanced DEF provides increased engine-out NOx reduction per unit volume of fluid in comparison to standard DEF, an engine using enhanced DEF can operate at higher temperatures which increase engine-out NOx but which also provide greater operating efficiency than the same engine using standard DEF while maintaining compliance with the same applicable tailpipe out NOx emission criteria as when the engine is using standard DEF.

A secondary reductant store holds solid, anhydrous urea or a similar anhydrous solid reductant capable of forming ammonia (e.g. ammonium carbamate). An engine control unit (ECU) controls the quantity of solid reductant and the quantity of DEF from the DEF storage tank which are mixed together to create “enhanced” DEF, a solution having urea greater than 32.5% wt. and water less than 67.5% wt. A reductant injection system injects DEF, either enhanced or unenhanced, in quantities controlled by a DEF supply module.

The ECU monitors engine operation and controls the proportions of solid reductant and standard DEF to avoid undissolved solids in the mixture and to create a desired urea concentration appropriate for how the engine is operating to enable tailpipe out NOx to comply with applicable tailpipe out NOx emission criteria while mitigating both ammonia slip and formation of deposits on aftertreatment system surfaces.

One general aspect of the claimed subject matter relates to a motor vehicle operated by a diesel engine having an exhaust aftertreatment system comprising an exhaust flow path having an entrance through which engine-out diesel exhaust enters and an exit through which treated diesel exhaust exits. A diesel oxidation catalyst (DOC) treats engine-out exhaust. A diesel particulate filter (DPF) treats exhaust flow from the DOC, and a main SCR catalyst has surfaces containing catalytic material across which exhaust flow from the DPF passes.

A diesel exhaust fluid (DEF) storage tank holds unenhanced DEF and a secondary reductant store holds anhydrous solid reductant capable of forming ammonia. Anhydrous solid reductant and unenhanced DEF mix in a mixing zone to create enhanced DEF, and a DEF injector injects enhanced DEF to entrain with exhaust flow from the DPF for enabling catalytic reduction of some NOx in exhaust flow across the catalytic material of the main SCR catalyst.

Another general aspect of the claimed subject matter relates to the diesel exhaust aftertreatment system just described.

Another general aspect of the claimed subject matter relates to a method of creating enhanced DEF.

The foregoing summary is accompanied by further detail of the disclosure presented in the Detailed Description below with reference to the following drawings which are part of the disclosure.

### BRIEF DESCRIPTION OF THE DRAWINGS

FIG. 1 shows a motor vehicle which is propelled by an internal combustion engine.

FIG. 2 is a general schematic diagram of the engine showing detail of its exhaust aftertreatment system.

FIG. 3 is a schematic diagram illustrating a first embodiment of a portion of the exhaust aftertreatment system.

FIG. 4 is a schematic diagram illustrating a second embodiment of a portion of the exhaust aftertreatment system.

FIG. 5 is a schematic diagram illustrating a third embodiment of a portion of the exhaust aftertreatment system.

FIG. 6 is a schematic diagram illustrating a fourth embodiment of a portion of the exhaust aftertreatment system.

FIG. 7 is a schematic diagram illustrating a fifth embodiment of a portion of the exhaust aftertreatment system.

FIG. 8 is a schematic diagram illustrating a sixth embodiment of a portion of the exhaust aftertreatment system.

FIG. 9 is a schematic diagram illustrating a sixth embodiment of a portion of the exhaust aftertreatment system.

### DETAILED DESCRIPTION

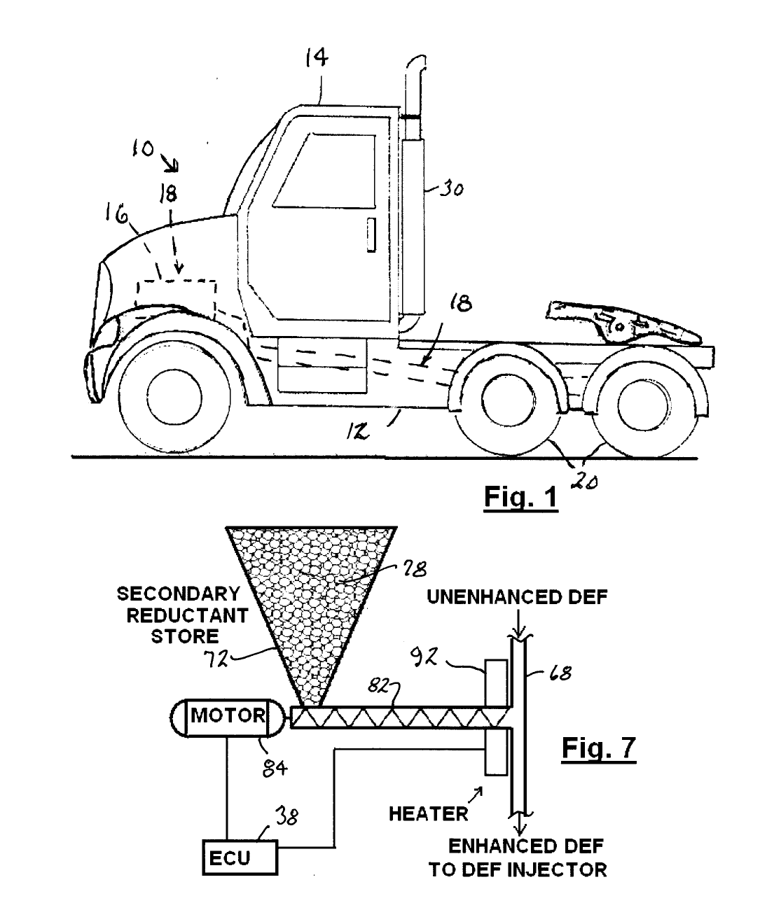

FIG. 1 shows a truck vehicle 10, such as a highway tractor for example, having a chassis 12 and a cab body 14 supported on a frame of chassis 12 which also supports a fuel-consuming engine 16 of a powertrain 18. Engine 16 operates through a drivetrain of powertrain 18 to drive wheels 20 which propel the truck vehicle on land.

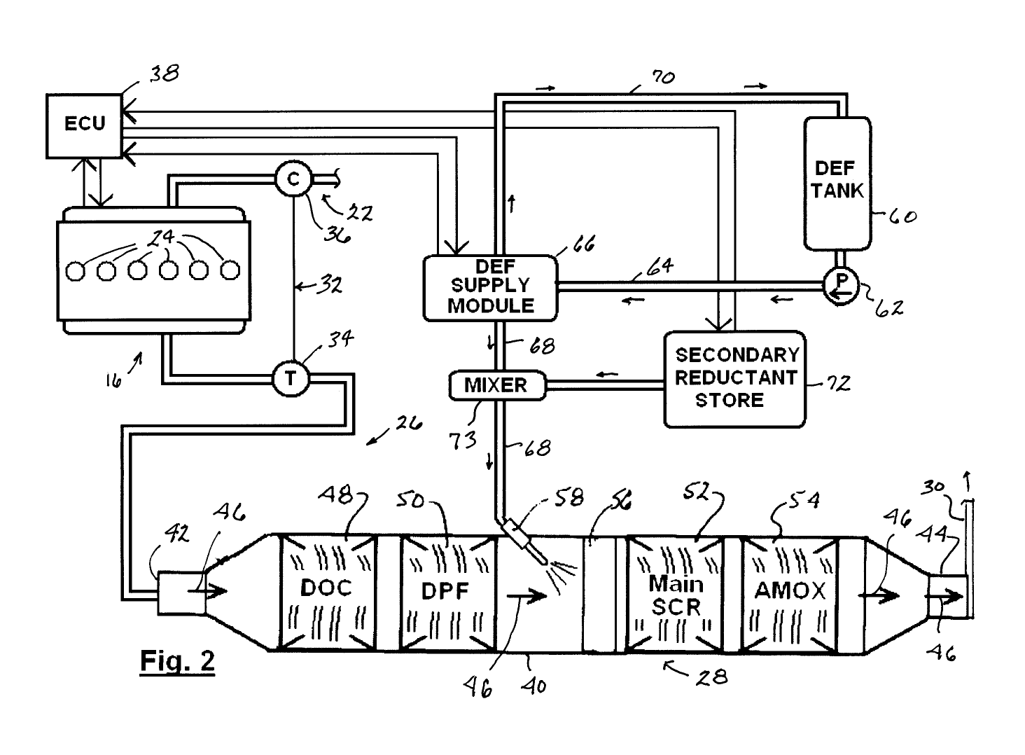

FIG. 2 shows engine 16 having an engine intake system 22 for conveying air to engine cylinders 24 into which fuel is injected and within which injected fuel is combusted to operate the engine. An engine exhaust system 26 conveys exhaust resulting from combustion of fuel in cylinders 24 to surrounding atmosphere. Exhaust system 26 includes an aftertreatment system 28 for treating “engine out” exhaust before exhaust passes into surrounding atmosphere through a tailpipe 30.

Engine 16 is representative of a turbocharged diesel engine which comprises a turbocharger 32 having a turbine 34 operated by engine out exhaust before exhaust enters aftertreatment system 28. Turbine 34 operates a compressor 36 to create charge air entering cylinders 24 from intake system 22. Other components associated with this type of engine, such as a charge air cooler for example, are not shown in the drawing.

An engine controller comprises a processor-based engine control unit (ECU) 38 which controls various aspects of engine operation, such as injection of fuel into engine cylinders 24. Control of fuel injection and other functions is accomplished by processing various input data to develop control data for controlling those functions.

Exhaust aftertreatment system 28 is shown in FIG. 2 to comprise structure through which exhaust is constrained to pass before exiting exhaust system 26. It should be understood that various components of the illustrated structure are shown schematically rather than as actual components, many of which are well-known in aftertreatment systems. Aftertreatment system 28 comprises an enclosure 40 providing an exhaust flow path between an exhaust entrance 42 at an upstream end, and an exhaust exit 44 at a downstream end. Arrows 46 indicate a direction of exhaust flow into, through, and out of the interior of enclosure 40. The exhaust flow is constrained to pass in succession across surfaces of a diesel oxidation catalyst (DOC) 48, through a diesel particulate filter (DPF) 50, across surfaces of a main SCR catalyst 52 and surfaces of an ammonia slip (AMOX) catalyst 54.

DOC 48 treats engine exhaust by removing certain entrained matter, such as the soluble organic fraction of diesel particulate matter. DPF 50 removes entrained soot from the exhaust. If exhaust temperature needs elevation for burning off trapped soot (i.e. regeneration), combustible hydrocarbons, available as diesel fuel from a vehicle's fuel tank, may be introduced into the exhaust ahead of DOC 48 via a fuel injector (not shown). Main SCR catalyst 52 treats engine exhaust by reducing NOx according to chemical reactions mentioned above. While any catalytic material which can withstand whatever DPF regeneration temperatures main SCR catalyst may be subjected to during DPF regenerations may be used, iron zeolite and copper zeolite are examples of catalyst materials suitable for main SCR catalyst 52. Ammonia slip catalyst 54 is placed after main SCR catalyst 52 to convert any ammonia leaving the latter into nitrogen and water vapor.

Between DPF 50 and SCR 52, exhaust flow is constrained to pass through a mixing zone comprising a mixer 56 which promotes mixing of exhaust with DEF which is injected via a DEF injector 58 to entrain and mix with exhaust flow before the flow reaches main SCR catalyst 52. An example of mixer 56 is a static mixer which is placed between DEF injector 58 and main SCR catalyst 52 and which promotes wide distribution of DEF within the exhaust flow before the flow reaches main SCR catalyst 52. Thermal energy in the exhaust flow vaporizes the DEF water component and decomposes the DEF urea component to create free ammonia molecules which attach to catalytic surface sites of main SCR catalyst 52 when a metal-exchanged zeolite is used.

Enclosure 40 may be mounted on a frame rail of chassis 12 or alternately the various components of aftertreatment system 28 may be housed within individual enclosures connected by pipes.

Standard DEF is stored in a DEF storage tank 60 which is typically mounted on truck vehicle 10 at a location exposed to ambient temperatures which if low enough will freeze DEF in the DEF storage tank. When not frozen, standard DEF is drawn from DEF storage tank 60 by a pump 62 through a supply conduit 64 and delivered to a DEF supply module 66 which, under control of ECU 38, delivers a controlled quantity of DEF to DEF injector 58 through a delivery conduit 68. Pumped DEF which is in excess of DEF delivered to DEF injector 58 returns from DEF supply module 66 to DEF storage tank 60 through a return conduit 70. A secondary reductant store 72 holds solid, anhydrous urea or a similar anhydrous solid reductant capable of forming ammonia (e.g. ammonium carbamate). Solid reductant material from store 72 is mixed with standard DEF from DEF storage tank 60 (represented generically by mixer 73) to create enhanced DEF.

ECU 38 monitors operation of engine 16 and controls proportions of secondary reactant solid and DEF being mixed to create a desired urea concentration for enhanced DEF appropriate for how engine 16 is operating to enable tailpipe out NOx to comply with applicable tailpipe out NOx emission criteria while mitigating both formation of deposits on surfaces of aftertreatment system 28 and occurrences of ammonia slip. ECU 38 controls both timing and quantity of secondary reductant which is mixed with standard DEF and may at times limit quantity of secondary reductant added to assure that all secondary reductant will be dissolved in enhanced DEF which is being injected.

Control of the injection of unenhanced DEF may be performed using known strategies, such as by processing measurements from NOx sensors (not shown) to calculate NOx reduction quantity and using those measurements to control quantity of unenhanced DEF as it is being injected so that calculated NOx reduction quantity meets a NOx reduction quantity target which provides compliance with applicable NOx emission criteria.

Control of the injection of enhanced DEF may also be performed using known strategies, such as by processing measurements from NOx sensors (not shown) to calculate NOx reduction quantity and using those measurements to control both the urea concentration of enhanced DEF to be injected and the quantity of enhanced DEF as it is injected so that calculated NOx reduction quantity meets a NOx reduction quantity target which provides compliance with applicable NOx emission criteria.

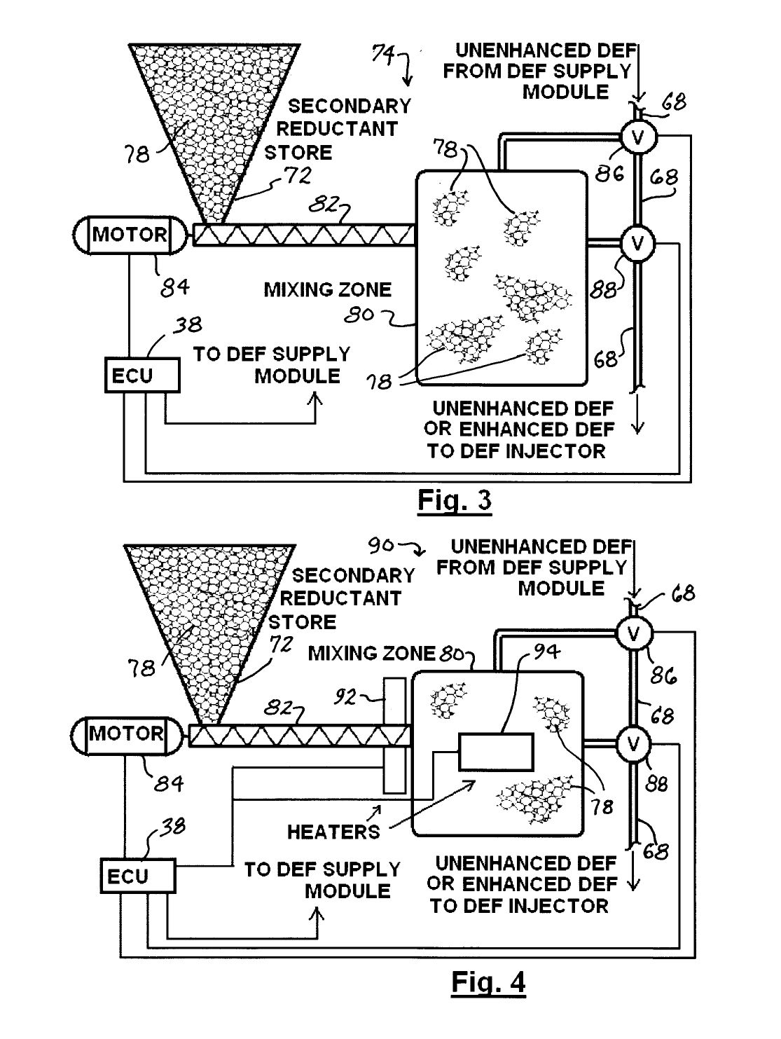

FIG. 3 shows a first embodiment of mixing equipment 74 for creating enhanced DEF. Mixing equipment 74 comprises a secondary reactant store 72 containing a multitude of prills 78 of secondary reactant and a mixing zone 80 where prills 78 and standard DEF mix to create enhanced DEF. A prill comprises a urea sphere having a diameter of approximately 1.65 mm. Although other forms of solid urea may be used, the use of prills of known size provides a convenient way to accurately measure quantity of urea being mixed with unenhanced DEF to create enhanced DEF.

Mixing zone 80 comprises an interior of a mixing chamber. Prills 78 are conveyed from store 76 into the interior of the mixing chamber by a screw augur conveyor 82 operated by an electric motor 84. Speed at which conveyor 82 operates determines the rate at which prills 78 are being added to unenhanced DEF, and hence control of conveyor speed is one factor in controlling urea concentration of enhanced DEF. Quantity of unenhanced DEF entering the interior of the mixing chamber is another factor.

Entry of unenhanced DEF into the mixing chamber is controlled by a first three-way valve 86, and flow of enhanced DEF from the interior of the mixing chamber is controlled by a second three-way valve 88. Valves 86, 88 are selectively operable to a first condition and a second condition. ECU 38 controls whether enhanced or unenhanced DEF is delivered to DEF injector 58 by controlling valves 86 and 88.

The first condition diverts unenhanced DEF from DEF supply module 66 to the interior of the mixing chamber for mixing with prills 78 to create enhanced DEF and allows enhanced DEF to be delivered from the mixing chamber to DEF injector 58 while simultaneously preventing unenhanced DEF from being delivered to the DEF injector. The second condition prevents unenhanced DEF from DEF supply module 66 from being diverted to the interior of the mixing chamber and allows unenhanced DEF to be delivered from the DEF supply module to DEF injector 58 while simultaneously preventing enhanced DEF in the mixing chamber from being delivered to the DEF injector.

When valves 86, 88 are allowing enhanced DEF to be delivered to DEF injector 58, its urea concentration is controlled by speed of conveyor 82 and quantity of unenhanced DEF being supplied to mixing zone 80 from DEF supply module 66.

When valve 86 is allowing unenhanced DEF to continue flowing through delivery conduit 68 to valve 88 while disallowing flow of unenhanced DEF into mixing zone 80, and valve 88 is disallowing flow of enhanced DEF out of mixing zone 80 while allowing flow of unenhanced DEF from valve 86 to continue flowing through to DEF injector 58, DEF injector 58 injects unenhanced DEF. Screw augur conveyor 82 is also stopped.

FIG. 4 shows a second embodiment of mixing equipment 90 for creating enhanced DEF. In all material respects of construction and operation, mixing equipment 90 is like mixing equipment 74, but further comprises a first heater 92 and a second heater 94, each of which is electrically operated. First heater 92 is disposed to begin heating prills 78 as they approach mixing zone 80 while second heater heats prills 78 and DEF within mixing zone 80. Each heater is independently controlled by ECU 38 to operate at its own selected temperature for its own selected length of time. Heating of prills at a location remote from the location at which prills enter conveyor 82 assures accuracy in quantity of urea being mixed with unenhanced DEF.

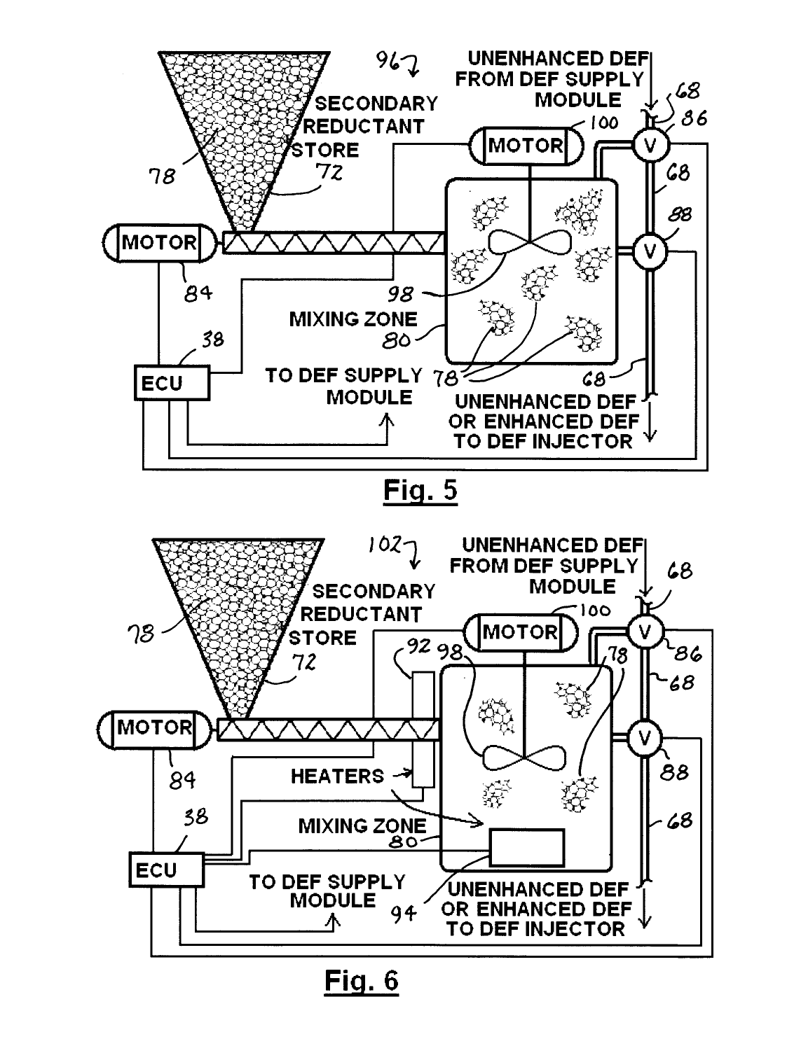

FIG. 5 shows a third embodiment of mixing equipment 96 for creating enhanced DEF. In all material respects of construction and operation, mixing equipment 90 is like mixing equipment 74, but further comprises an agitator 98 for agitating mixture of prills and unenhanced DEF within mixing zone 80. Agitator 98 is operated by an electric motor 100 controlled by ECU 38.

FIG. 6 shows a fourth embodiment of mixing equipment 102 for creating enhanced DEF. In all material respects of construction and operation, mixing equipment 102 is like mixing equipment 74, but combines the heaters 92, 94 of the second embodiment with the agitator 98 and motor 100 of the third embodiment.

FIG. 7 shows a fifth embodiment for mixing unenhanced DEF and anhydrous solid reductant to create enhanced DEF. Prills 78 are conveyed from store 76 by screw augur conveyor 82 directly into delivery conduit 68 to mix with unenhanced DEF from DEF supply module 66 flowing toward DEF injector 58. Hence, the mixing zone is within delivery conduit 68 rather than in a distinct mixing zone external to delivery conduit 68. Heater 92 is disposed to heat prills 78 before they enter delivery conduit 68.

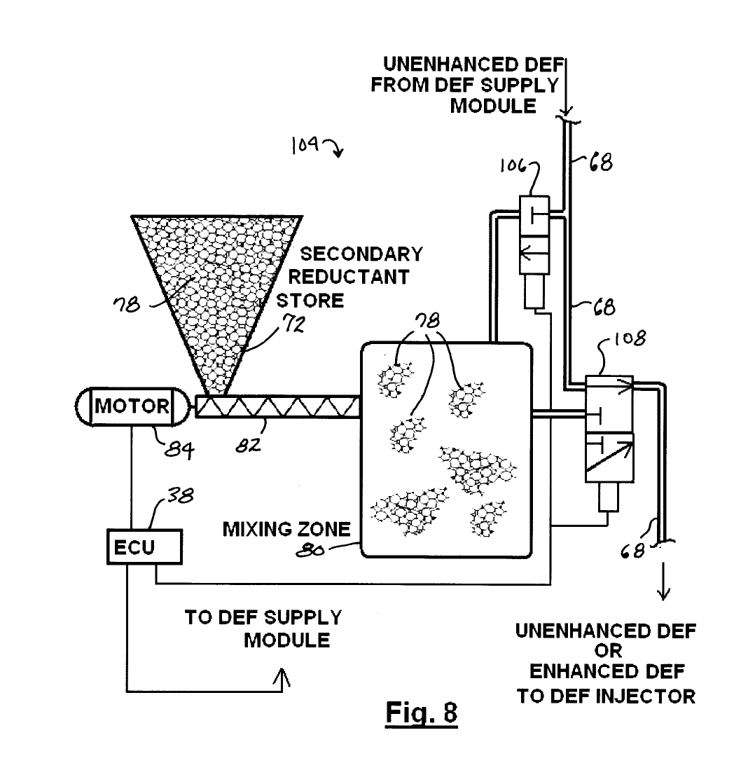

FIG. 8 shows a sixth embodiment of mixing equipment 104 which is like mixing equipment 74 except for the valve arrangement. A shut-off valve 106 and a two-way directional control valve 108 are controlled by ECU 38. FIG. 8 shows the second condition, as described earlier for FIGS. 3-6, but now with shut-off valve 106 preventing flow of unenhanced DEF into mixing zone 80 while directional valve 108 allows flow of unenhanced DEF from DEF supply module 66 to DEF injector 58. When ECU 38 operates the valves to the first condition, which was described earlier for FIGS. 3-6, shut-off valve 106 allows flow of unenhanced DEF into mixing zone 80 while directional valve 108 disallows flow of unenhanced DEF from DEF supply module 66 to DEF injector 58 and allows flow of enhanced DEF from mixing chamber 80 to DEF injector 58.

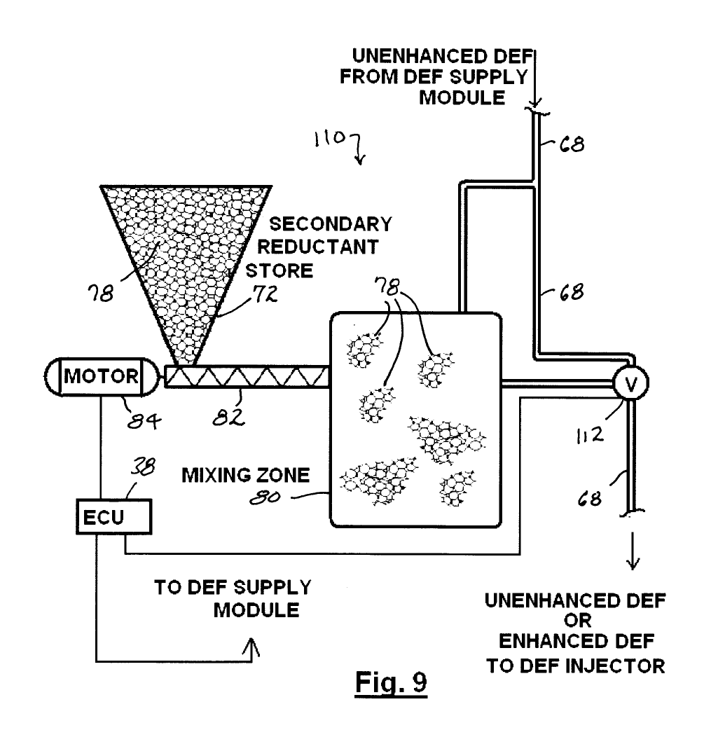

FIG. 9 shows a seventh embodiment of mixing equipment 110 which is like mixing equipment 74 except for the valve arrangement. An apportioning valve 112 is controlled by ECU 38 to selectively allow 1) only unenhanced DEF to be delivered to DEF injector 58, 2) only enhanced DEF to be delivered to DEF injector 58, or 3) a blend of unenhanced DEF and enhanced DEF to create blended enhanced DEF which is delivered to DEF injector 58.

Although not shown, each embodiment of mixing equipment 104, 110 may have agitators and/or heaters as described for prior embodiments.

If urea in other than the form of prills is used, it may be mechanically processed to provide sizes suitable for mixing, and other ways of measuring quantity may be employed.

While the diesel engine which has been described is one example of an internal combustion engine, enhanced DEF and the disclosed method of creating it may be used in any internal combustion engine which runs lean of stoichiometric (i.e. any lean burn engine).

What is claimed is:

1. A motor vehicle propelled by a diesel engine comprising an exhaust aftertreatment system forming an exhaust flow path having an entrance through which engine-out diesel exhaust enters and an exit through which treated diesel exhaust exits,
the exhaust flow path containing: 1) a diesel oxidation catalyst (DOC) for treating engine-out exhaust, 2) a diesel particulate filter (DPF) for treating exhaust flow from the DOC, and 3) a main SCR catalyst having surfaces containing catalytic material across which exhaust flow from the DPF passes;
a diesel exhaust fluid (DEF) storage tank which holds unenhanced DEF;
a secondary reductant store which holds anhydrous solid reductant capable of forming ammonia;
a mixing zone in which anhydrous solid reductant and unenhanced DEF are mixed to create enhanced DEF;
and a DEF injector for injecting enhanced DEF to entrain with exhaust flow from the DPF for enabling catalytic reduction of some NOx in exhaust flow across the catalytic material of the main SCR catalyst.

2. A motor vehicle as set forth in claim 1 in which the mixing zone is within a delivery conduit through which a DEF supply module delivers DEF from the DEF storage tank to the DEF injector.

3. A motor vehicle as set forth in claim 2 in which the anhydrous solid reductant comprises prills and a screw augur conveyor conveys prills from the secondary reductant store to the delivery conduit.

4. A motor vehicle as set forth in claim 1 in which the mixing zone comprises an interior of a mixing chamber which is external to a delivery conduit through which a DEF supply module delivers DEF from the DEF storage tank to the DEF injector.

5. A motor vehicle as set forth in claim 4 in which the anhydrous solid reductant comprises prills, and a screw augur conveyor conveys prills from the secondary reductant store to the interior of the mixing chamber.

6. A motor vehicle as set forth in claim 5 including at least one heater for heating prills after they have left the secondary reactant store.

7. A motor vehicle as set forth in claim 6 in which the at least one heater comprises a first heater for heating prills being conveyed by the screw augur conveyor and a second heater for heating prills as they are mixing with DEF within the interior of the mixing chamber.

8. A motor vehicle as set forth in claim 4 in which the anhydrous solid reductant comprises prills and the mixing zone comprises an interior of a mixing chamber within which an agitator is disposed to agitate prills as they are mixing with DEF.

9. A motor vehicle as set forth in claim 8 in which a screw augur conveyor conveys prills from the secondary reductant store to the interior of the mixing chamber, and least one heater heats the prills.

10. A motor vehicle as set forth in claim 9 in which the at least one heater comprises a first heater for heating prills being conveyed by the screw augur conveyor and a second heater for heating prills as they are mixing with DEF within the interior of the mixing chamber.

11. A motor vehicle as set forth in claim 4 including valves which are selectively operable to a first condition which diverts unenhanced DEF from the DEF supply module to the interior of the mixing chamber for mixing with anhydrous solid reductant to create enhanced DEF and allows enhanced DEF to be delivered from the mixing chamber to the DEF injector while simultaneously preventing unenhanced DEF from being delivered to the DEF injector, and to a second condition which prevents unenhanced DEF from the DEF supply module from being diverted to the interior of the mixing chamber and allows unenhanced DEF to be delivered from the DEF supply module to the DEF injector while simultaneously preventing enhanced DEF in the mixing chamber from being delivered to the DEF injector.

12. A motor vehicle as set forth in claim 4 including valves which are selectively operable to a first condition which allows only unenhanced DEF to be delivered to the DEF injector, to a second condition which allow only enhanced DEF from the mixing chamber to be delivered to the DEF injector, and to a third condition which mixes unenhanced DEF and enhanced DEF from the mixing chamber to create blended enhanced DEF which is delivered to the DEF injector.

13. A diesel engine exhaust aftertreatment system comprising an exhaust flow path having an entrance through which engine-out diesel exhaust enters and an exit through which treated diesel exhaust exits, the aftertreatment system comprising:
1) a diesel oxidation catalyst (DOC) for treating engine-out exhaust, 2) a diesel particulate filter (DPF) for treating exhaust flow from the DOC, and 3) a main SCR catalyst having surfaces containing catalytic material across which exhaust flow from the DPF passes;
a diesel exhaust fluid (DEF) storage tank which holds unenhanced DEF;
a secondary reductant store which holds anhydrous solid reductant capable of forming ammonia;
a mixing zone in which anhydrous solid reductant and unenhanced DEF mix to create enhanced DEF;
and a DEF injector for injecting enhanced DEF to entrain with exhaust flow from the DPF for enabling catalytic reduction of some NOx in exhaust flow across the catalytic material of the main SCR catalyst.

14. A diesel engine exhaust aftertreatment system as set forth in claim 13 in which the mixing zone is within a delivery conduit through which a DEF supply module delivers DEF from the DEF storage tank to the DEF injector.

15. A diesel engine exhaust aftertreatment system as set forth in claim 14 in which the anhydrous solid reductant comprises prills and a screw augur conveyor conveys prills from the secondary reductant store to the delivery conduit.

16. A diesel engine exhaust aftertreatment system as set forth in claim 13 in which the mixing zone comprises an interior of a mixing chamber which is external to a delivery conduit through which a DEF supply module delivers DEF from the DEF storage tank to the DEF injector.

17. A diesel engine exhaust aftertreatment system as set forth in claim 16 in which the anhydrous solid reductant comprises prills, and a screw augur conveyor conveys prills from the secondary reductant store to the interior of the mixing chamber.

18. A method for aftertreatment of engine-out exhaust from an internal combustion engine flowing through an exhaust flow path having an entrance through which untreated engine-out exhaust enters and an exit through which treated exhaust exits, the method comprising:
in a mixing zone, mixing anhydrous solid reductant capable of forming ammonia and unenhanced DEF to create enhanced DEF;
injecting enhanced DEF upstream of a main SCR catalyst to entrain with exhaust flow for enabling catalytic reduction of some NOx in exhaust flow across the catalytic material of the main SCR catalyst.

19. A method as set forth in claim 18 further comprising using a diesel oxidation catalyst (DOC) in the flow path upstream of the main SCR catalyst to treat engine-out exhaust and using a diesel particulate filter (DPF) downstream of the DOC and upstream of the main SCR catalyst to treat exhaust coming from the DOC.

20. A method as set forth in claim 18 further comprising blending enhanced DEF from the mixing zone and unenhanced DEF to create blended enhanced DEF and injecting blended enhanced DEF upstream of the main SCR catalyst.
